(19) United States
(12) Patent Application Publication
(10) Pub. No.: US 2002/0070472 A1
(43) Pub. Date: Jun. 13, 2002

(54) Injection moulding method and product

(76) Inventor: Donald Shaw, Agincourt (CA)

Correspondence Address: McFadden, Fincham, Suite 606, 225 Metcalfe Street, Ottawa, ON, K2P 1P9, CA

(21) Appl. No.: 09/734,879

(22) Filed: Dec. 13, 2000

Related U.S. Application Data
(60) Provisional application No. 60/172,147, filed on Dec. 17, 1999.

(51) Int. Cl. B29C 44/06; B29C 44/08; A41G 1/00

(52) U.S. Cl. 264/45.5; 428/26; 264/55

(57) ABSTRACT

The present invention relates to a method of injection moulding an ornamental product of thermoplastic material the improvement comprising adding a foaming agent to the thermoplastic material, differentially cooling the product inside the mould whereby the parts to be expanded are cooled sufficiently to form a skin, but where said parts have a temperature remaining high enough to permit foaming expansion outside the mould while the balance of the product is cooled below the solidification temperature of the polymer.

### FIELD OF INVENTION

This invention relates to injection moulding and in particular a method for injection moulding ornamental products.

### BACKGROUND

Injection moulding methods for the fabrication of thermoplastic materials are well known in the art. Typically a viscous resin is pushed, by means of a plunger, out of a heated cylinder into a water-chilled mould, where it is cooled before removal.

The use of foaming agents in injection moulding is also known. A foaming agent can be used to form a thermoplastic product which has a skin on the outside and a less dense “foamed” core. The foaming of the product, however, is controlled within the mould and it does not expand beyond the confines of the mould. Typical cycle times from injection to cooling of prior art products is about 60 seconds or more.

It is desirable to have a method for forming a product and a product formed thereby which expands outside the mould in which it is produced, to produce moulded ornamental products.

### SUMMARY OF THE INVENTION

In accordance with an embodiment of the present invention there is provided an improved method of injection moulding of thermoplastic material with a foaming agent added to the thermoplastic material. The improvement comprises: effecting expansion of a portion of the thermoplastic material following removal of the thermoplastic material from the mould whereby the size of the expanded portions are larger than that of the mould corresponding to those portions.

In accordance with another embodiment of the present invention, there is provided a method of injection moulding a thermoplastic material to produce a moulded product. The method comprises the steps of mixing a foaming agent with a thermoplastic material to form a thermoplastic mixture; injecting the mixture into a mould; cooling the mould for a time sufficient to significantly cool desired portions of the moulded product to prevent further expansion and to maintain heat in other desired portions to permit further expansion on removal of the product from the mould; and removing the product from the mould to permit further cooling of the product under atmospheric conditions and permit further expansion of desired portions of the product outside the mould.

A still further embodiment of the present invention provides an improved injection moulded thermoplastic product comprised of a thermoplastic resin and a foaming agent, the improvement comprising sections of the product being of a larger dimension than the mould due to maintaining sufficient heat in desired sections to permit continued activation of the foaming agent after removal of the product from the mould.

In a further aspect of the present invention, there is provided an injection moulded product made by differentially cooling of a portion of the product inside the mould with respect to the balance of the product whereby the differentially cooled portion is expanded outside the mould.

In a preferred embodiment, there is provided an injection moulded thermoplastic product wherein the expanded portions of the product are formed of an outer skin with an inner core and an intermediate layer between the inner core and the outer skin. The inner core is less dense than the outer skin and the intermediate layer. The outer skin is the densest of all the layers.

In preferred embodiments polypropylene is utilized as the thermoplastic material. However, it will be understood that any suitable thermoplastic material could be utilized, such as but not limited to polyethylene and other similar materials.

Any commerically available foaming agent can be utilized as the foaming agent in the present case. In its most preferred form, the foaming agent utilized is one which includes a heat stabilizer therein. In a particularly preferred embodiment, sodium bicarbonate is utilized as the foaming agent although, as noted hereinabove, any other suitable foaming agent could be utilized.

Having thus generally described the invention, reference will now be made to the accompanying drawings illustrating preferred embodiments and in which:

### BRIEF DESCRIPTION OF THE DRAWINGS

FIG. 1 is a perspective view of a conventional thermoplastic tulip product formed using conventional plastic injection;

FIG. 2 is a perspective view of a thermoplastic tulip product formed according to the present invention;

FIG. 3 is a cross section of a petal of the tulip of FIG. 1; and

FIG. 4 is a cross section of the corresponding petal of the tulip of FIG. 2.

### DETAILED DESCRIPTION OF THE PREFERRED EMBODIMENTS

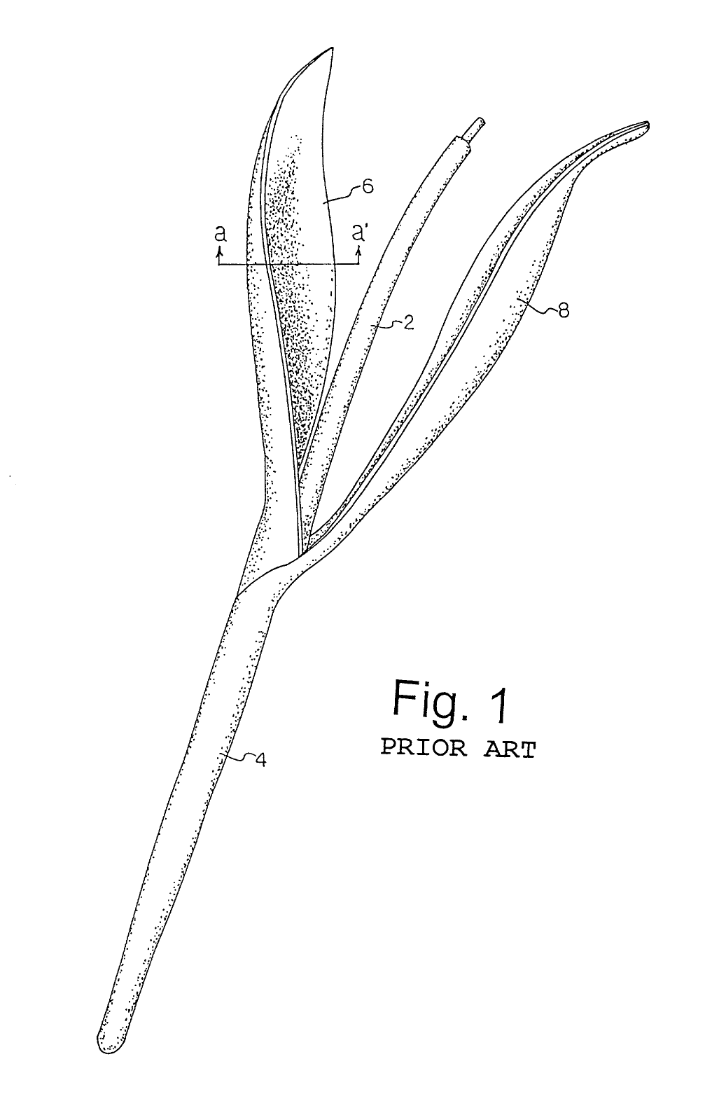

FIG. 1 shows a conventional thermoplastic tulip product having an upper stem 2, a lower stem 4 and petals 6 and 8.

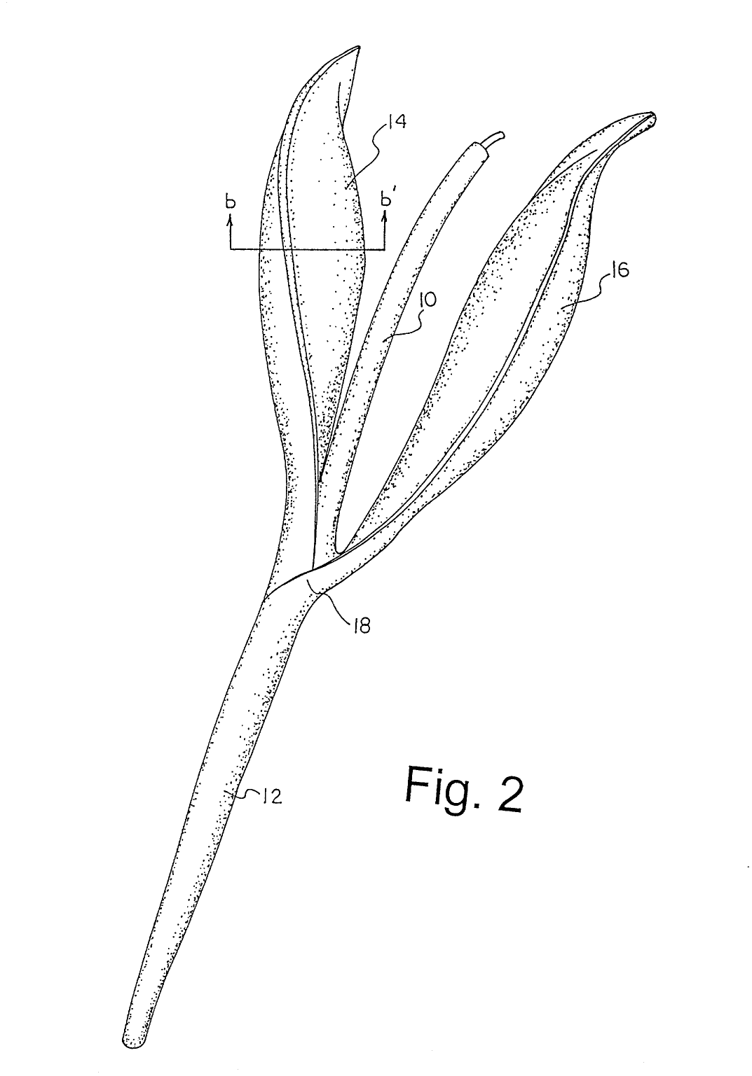

FIG. 2 shows a thermoplastic ornamental tulip product of the present invention having an upper stem 10 and lower stem 12 and petals 14 and 16. The tulip product has been made using the same mould as the prior art tulip shown in FIG. 1. The petals 14 and 16, however, are significantly enlarged and expanded as compared to the petals 6 and 8. The mid-region 18 of the stem is similarly enlarged while the upper stem 10 and lower stem 12 are similar in size with respect to upper and lower stems 2 and 4 respectively of the prior art tulip product.

By way of example, a tulip product according to the present invention can be made using polypropylene mixed with a sodium bicarbonate foaming agent. The polypropylene/sodium bicarbonate mixture was injected into a water cooled tulip mould using conventional equipment and methods with a total cycle time of 35 to 50 seconds. The product was permitted to cool partially within the mould followed by removal of the tulip product from the mould. The tulip product was then permitted to completely cool under atmospheric temperatures. Expansion of the petals 14 and 16 to a size at least two to three times larger than the size of the mould occurs outside of the mould due to the foaming agent and to the differential cooling of the product.

The amount of expansion can be controlled by varying the amount of foaming agent used in the polypropylene mixture and the amount of differential cooling. The method of the invention results in products with expanded parts being produced using shorter cooling times. This in turn increases the rate of production and provides for a product with a more “real” appearance.

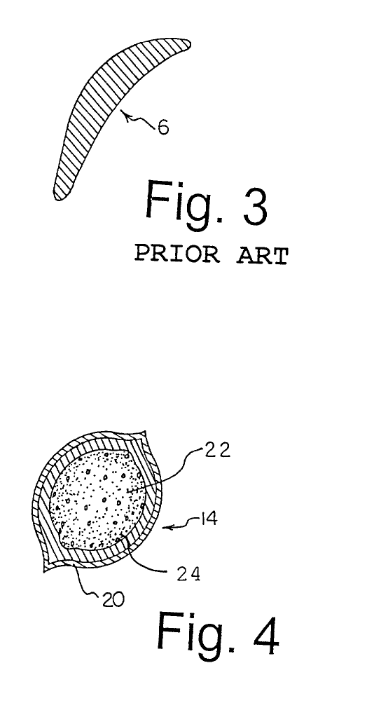

The cross section of the petals 6 and 8 of the prior art tulip are substantially homogeneous and basically conform to the shape of the mould. This is best shown in FIG. 3 which is a cross section of petal 6 taken along line a, a′.

Corresponding petal 14 of the present invention is shown in cross section in FIG. 4 taken along line b, b′ of FIG. 2. Petal 14 of the present invention has an outer skin 20 and a less dense “foamed” core 22. There is also a substantially concentric middle layer or area 24 between the outer skin 20 and the foamed inner core 22. This middle layer 24 is somewhat less dense than the outer skin 20 but is denser than the central core 22. This is due to the faster cooling of the outside of the pedal compared to the cooling of the inner core which tends to maintain the heat longer and thus permits greater activation of the foaming agent.

It will be understood that various conventional thermoplastic resins and foaming agents may be used. In the preferred embodiment, polypropylene is utilized as the thermoplastic resin and sodium bicarbonate is utilized as the foaming agent. However, as will be readily apparent, any suitable thermoplastic resin/foaming agent combinations can be utilized in the present invention.

While there have been shown and described what are considered to be the preferred embodiments of the invention, it will, of course, be understood that various modifications and changes in form or detail can readily be made without departing from the spirit of the invention. It is therefore intended that the invention not be limited to the exact form and detail herein shown and described nor to anything less than the whole of the invention herein disclosed as hereinafter claimed.

I claim:

1. In a method of injection moulding of thermoplastic material with a foaming agent added to the thermoplastic material, the improvement comprising:
effecting expansion of a portion of the thermoplastic material following removal of the thermoplastic material from the mould whereby the size of the expanded portions are larger than that of the mould corresponding to those portions.

2. The method of claim 1 wherein said expansion is effected by maintaining sufficient heat in the portion to thereby effect continued activation of the foaming agent after removal of the material from the mould.

3. A method of injection moulding a thermoplastic material to produce a moulded product, the method comprising the steps of:
mixing a foaming agent with a thermoplastic material to form a thermoplastic mixture;
injecting the mixture into a mould;
cooling the mould for a time sufficient to significantly cool desired portions of the moulded product to prevent further expansion and to maintain heat in other desired portions to permit further expansion on removal of the product from the mold; and
removing the product from the mould to permit further cooling of the product under atmospheric conditions and permit further expansion of desired portions of the product outside the mould.

4. The method of claim 3, wherein said thermoplastic material is polypropylene.

5. The method of claim 3, wherein said foaming agent is sodium bicarbonate.

6. The method of claim 1, wherein said thermoplastic material is polypropylene.

7. The method of claim 1, wherein said foaming agent is sodium bicarbonate.

8. The method according to claim 1 wherein the expanded portions are formed of an outer skin with a core bounded by the skin, the core being less dense than the outer skin.

9. The method of claim 1, wherein a total cycle time from injection of the thermoplastic material into the mould to cooling is about 40 seconds.

10. The method according to claim 3, wherein the expanded portions are formed of an outer skin with a core bounded by the skin, the core being less dense than the outer skin.

11. The method of claim 3, wherein a total cycle time from injection of the thermoplastic material into the mould to cooling is about 40 seconds.

12. In an injection moulded thermoplastic product comprised of a thermoplastic resin and a foaming agent, the improvement comprising sections of the product being of a larger dimension than the mould due to maintaining sufficient heat in desired sections to permit continued activation of the foaming agent after removal of the product from the mould.

13. The injection moulded product of claim 12, wherein the thermoplastic resin is polypropylene.

14. The injection moulded product of claim 12, wherein the foaming agent is sodium bicarbonate.

15. An injection moulded thermoplastic product made according to the method of claim 1.

16. An injection moulded thermoplastic product made according to the method of claim 3.
